(19) United States
(12) Patent Application Publication
(10) Pub. No.: US 2010/0176114 A1
(43) Pub. Date: Jul. 15, 2010

(54) OVEN WITH IMPROVED TOASTING FUNCTION

(76) Inventors: GARY W. JOHNSON, Norwalk, CT (US); Jill Kreutzer Orent, Westport, CT (US); Kam Fai Fung, Tuen Mun (HK)

Correspondence Address: Lawrence Cruz;Conair Corporation, One Cummings Point Road, STAMFORD, CT, 06902, US

(21) Appl. No.: 12/635,941

(22) Filed: Dec. 11, 2009

Related U.S. Application Data
(60) Provisional application No. 61/122,645, filed on Dec. 15, 2008.

(51) Int. Cl. A21B 1/22

(52) U.S. Cl. 219/409

(57) ABSTRACT

A toaster oven features a moving, pivoting heater element to yield improved toasting capability. The toaster oven also cooks food with traditional bake, broil and toast functions, but also has the capability of having an additional heater element that can be positioned closely to the bread rack to give optimum toasting performance. Once the toasting function is completed, the additional heating can be repositioned out of the way, providing increased oven height for cooking bigger sized items.

### CROSS-REFERENCE TO RELATED APPLICATIONS

This application claims priority to U.S. Provisional Application No. 61/122,645 filed Dec. 15, 2008, entitled “OVEN WITH IMPROVED TOASTING FUNCTION,” Gary Wayne Johnson and Jill Kreutzer Orent, inventors, which application is incorporated herein by reference for all purposes as though fully set forth herein.

### BACKGROUND OF THE INVENTION

This invention relates to a toaster oven with movable heating element for improved toasting function.

Prior art toaster ovens typically include a housing and a cooking chamber defined within the housing by a top wall, a bottom wall, side walls and a rear wall. A door is pivotally mounted to the housing and pivotal between an open position whereby food items can be inserted and removed from the cooking chamber and a closed position closing the cooking chamber.

Toaster ovens are useful in a wide variety of cooking processes, including baking, warming, broiling, browning and toasting. Heating elements are mounted to or near the top panel and the bottom panel. Typically, the bottom panel heating element may be used for baking functions whereas the top panel heating element may be used for broiling functions. As the size of toaster ovens continue to increase, yielding larger capacities, this larger capacity greatly diminishes the toasting performance of the toaster oven.

It is well known that ovens can provide toasting functions but they take longer and provide sub-par toast quality when compared to a traditional toaster. What is needed is to provide a dedicated toasting compartment that will provide optimum toasting results yet having the ability to provide increased oven height when the oven is being used for baking and broiling.

### SUMMARY OF THE INVENTION

It is an object of the invention to provide a toaster oven with improved toasting capability.

It is a further object of the invention to provide a toaster oven with a movable heating element to yield improved toasting capability.

A toaster oven according to the invention features a moving, pivoting heater element to yield improved toasting capability. While the inventive toaster oven also cooks food with traditional bake, broil and toast functions, it also has the capability of having an additional heater element that can be positioned closely to the bread rack to give optimum toasting performance. Once the toasting function is completed, the additional heating can be repositioned out of the way, providing increased oven height for cooking bigger sized items.

Other features and advantages of the invention will be clear from the following description of preferred embodiments of the invention. It is to be understood that the foregoing general description and the following detailed description are exemplary and explanatory but are not to be restrictive of the invention. The accompanying drawings, which are incorporated in and constitute a part of this invention, illustrate embodiments of the invention and, together with the description, serve to explain the principles of the invention in general terms. Like numerals refer to like parts throughout the disclosure.

### BRIEF DESCRIPTION OF THE INVENTION

The foregoing aspects and other features of the present invention are explained in the following description, taken in connection with the accompanying drawings, wherein:

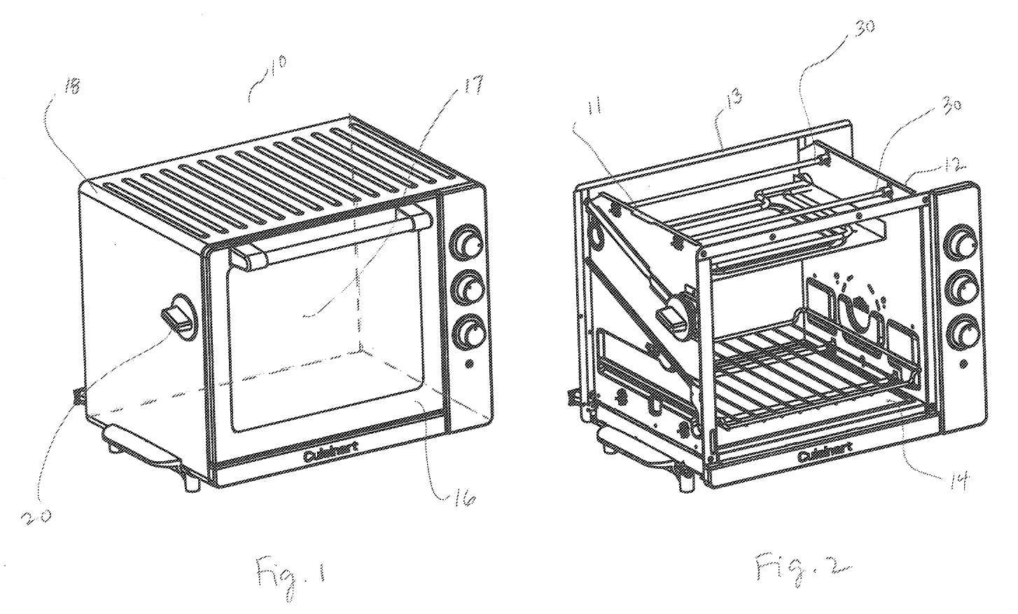

FIG. 1 is a perspective drawing of a toaster oven of the present invention;

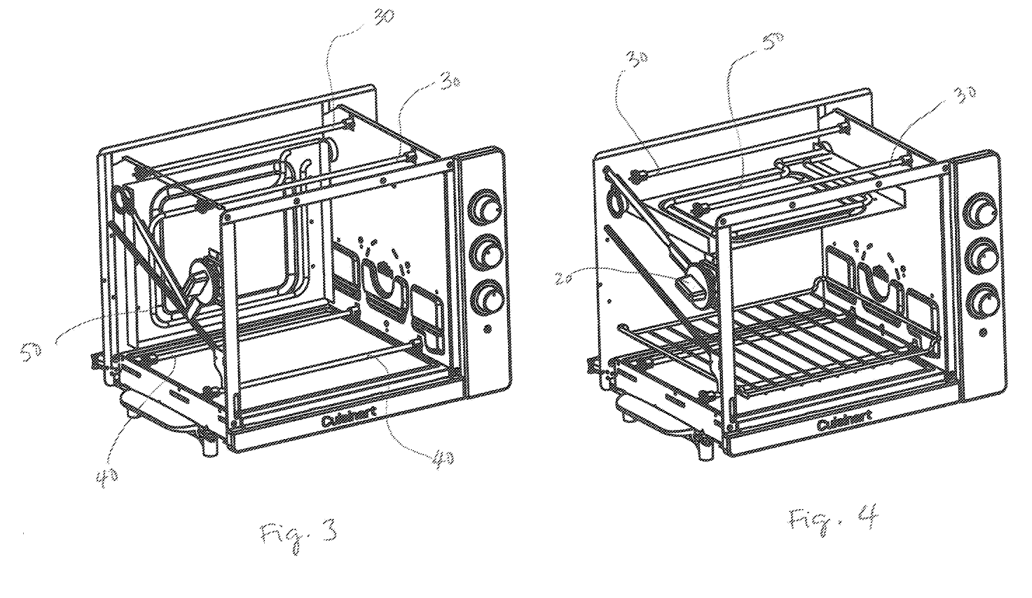

FIG. 2 is a perspective drawing revealing the mechanisms of a movable heating element of a toaster oven of the present invention;

FIG. 3 is a perspective drawing revealing the mechanisms of a movable heating element of a toaster oven of the present invention;

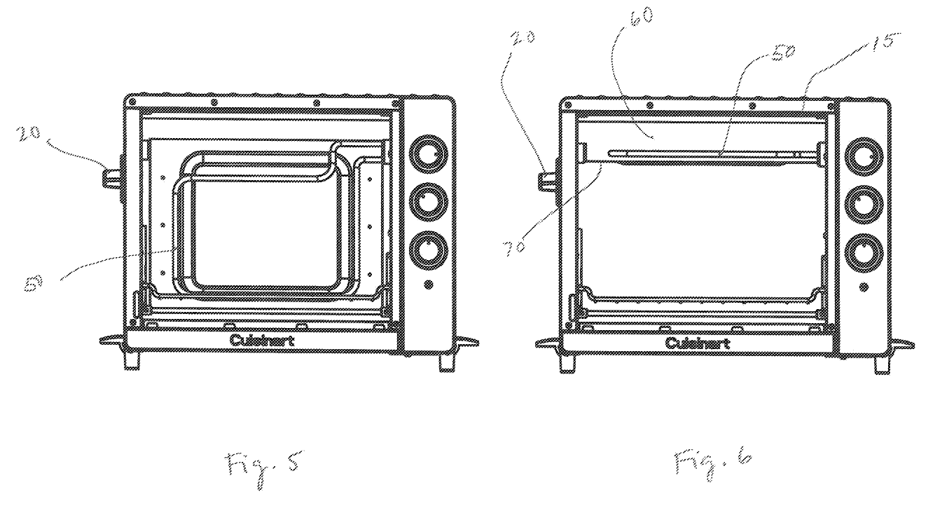

FIG. 4 is a perspective drawing revealing the mechanisms of a movable heating element of a toaster oven of the present invention;

FIG. 5 is a front view of the toaster oven of the present invention;

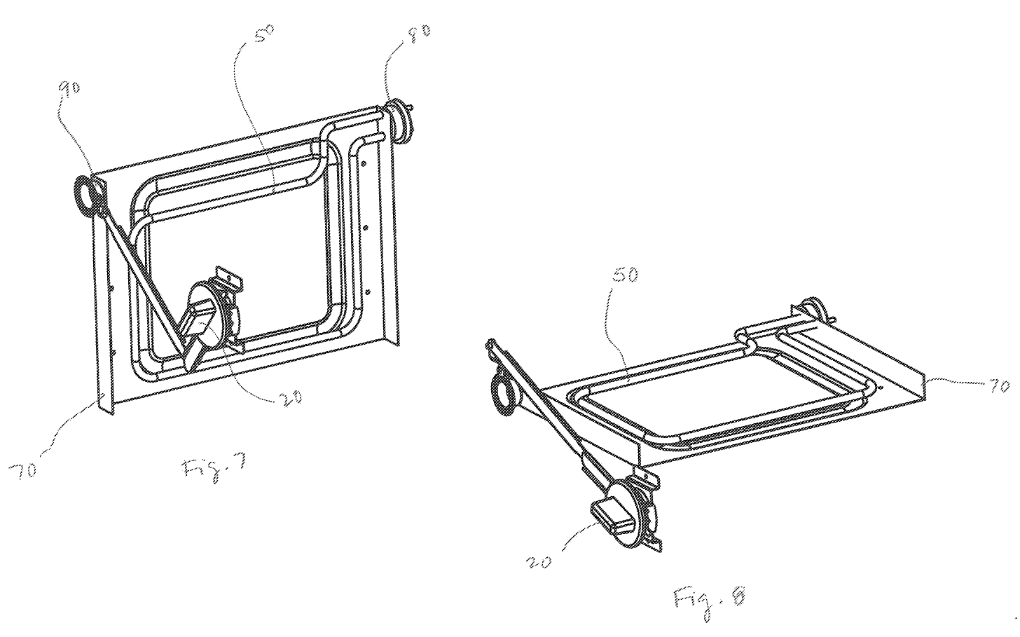

FIG. 6 is a front view of the toaster oven of the present invention;

FIG. 7 is a perspective drawing of a movable heating element of the toaster oven of the present invention in a vertical position;

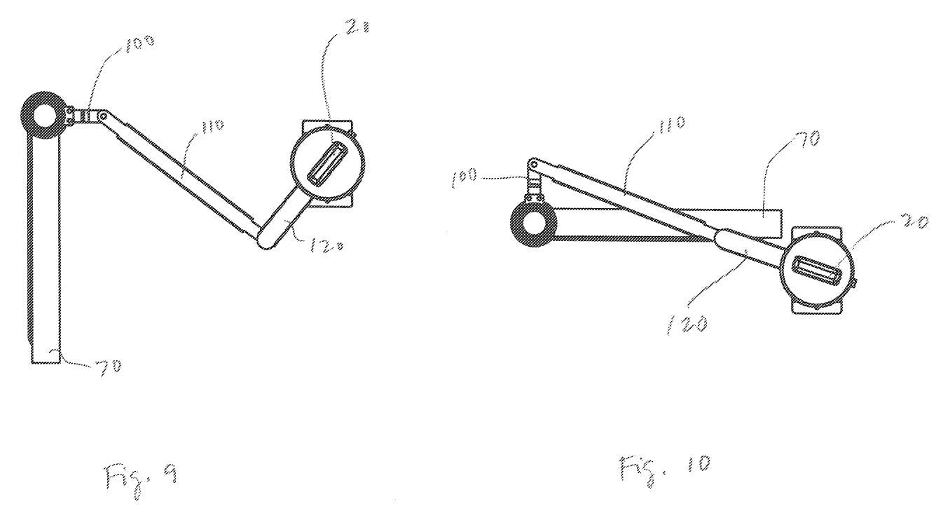

FIG. 8 is a perspective drawing of a movable heating element of the toaster oven of the present invention in a horizontal position;

FIG. 9 is a side view of a movable heating element of the toaster oven of the present invention in a vertical position;

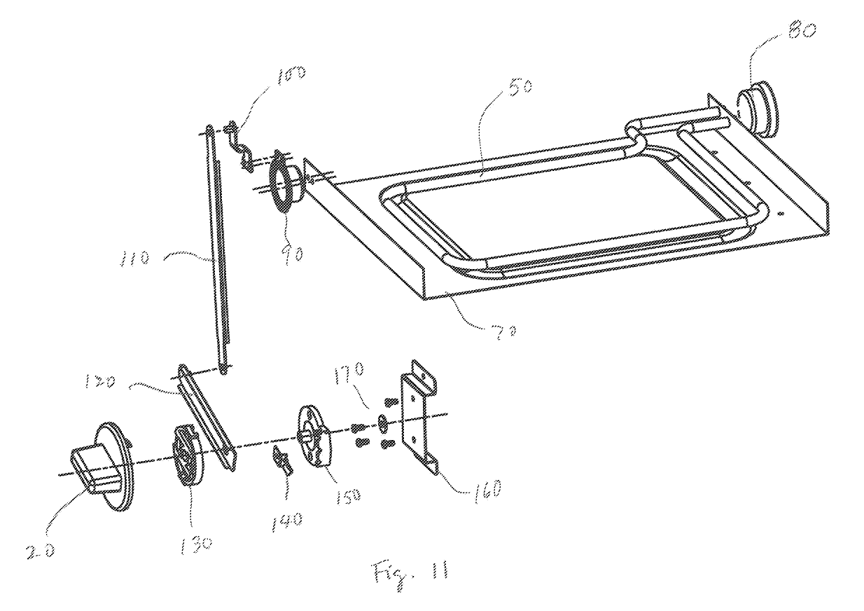

FIG. 10 is a side view of a movable heating element of the toaster oven of the present invention in a horizontal position;

FIG. 11 is an exploded view of a movable heating element of the toaster oven of the present invention;

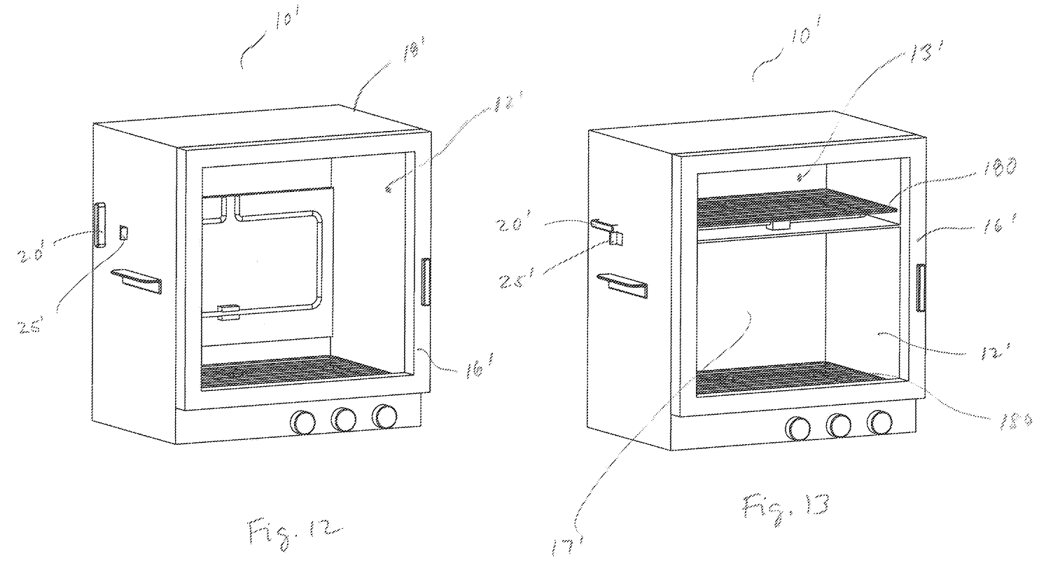

FIG. 12 is a perspective drawing of another embodiment of a toaster oven of the present invention;

FIG. 13 is a perspective drawing of another embodiment of a toaster oven of the present invention;

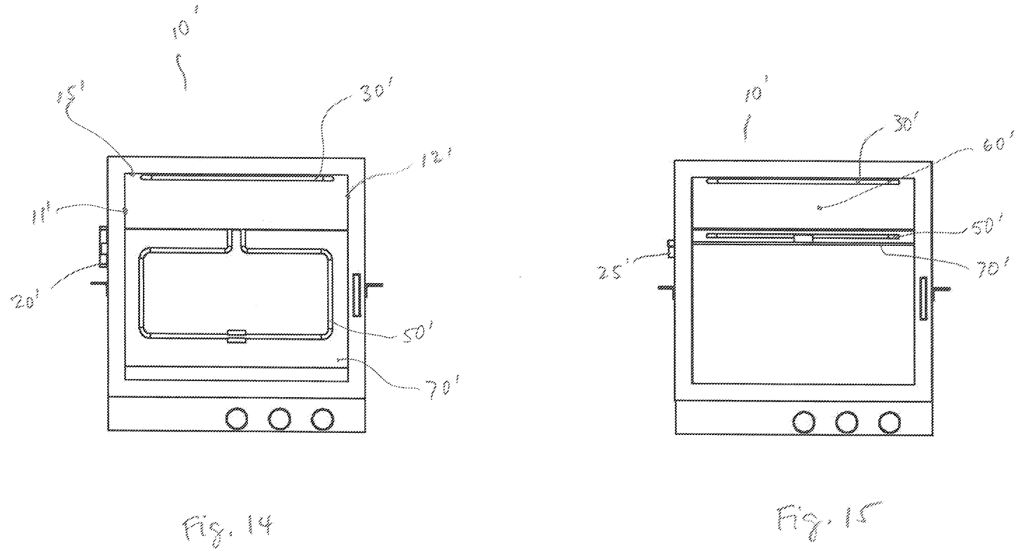

FIG. 14 is a front view of the toaster oven of the present invention depicted in FIG. 12;

FIG. 15 is a front view of the toaster oven of the present invention depicted in FIG. 13;

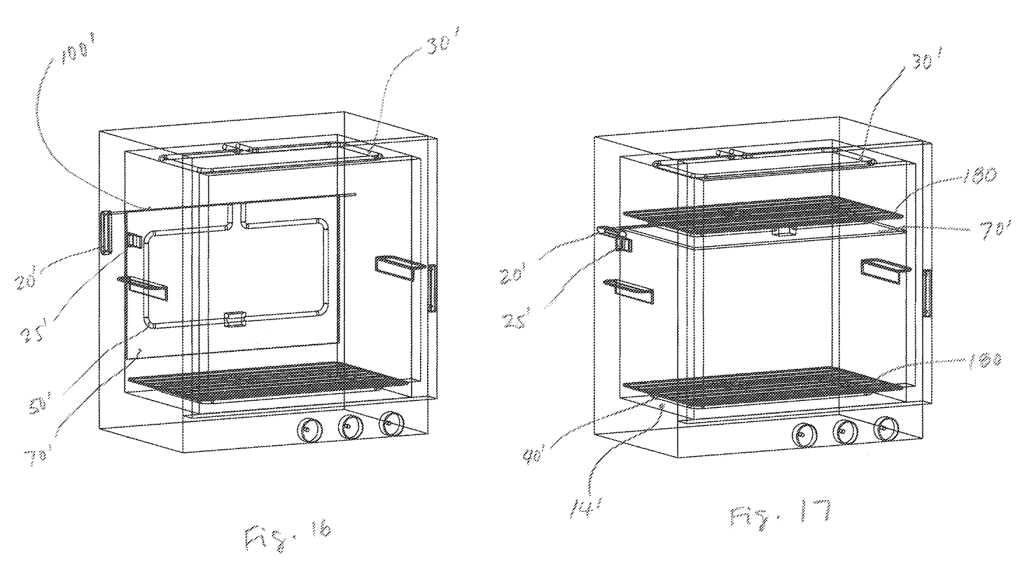

FIG. 16 is a perspective drawing revealing another embodiment of the mechanisms of a movable heating element of a toaster oven of the present invention;

FIG. 17 is a perspective drawing revealing another embodiment of the mechanisms of a movable heating element of a toaster oven of the present invention;

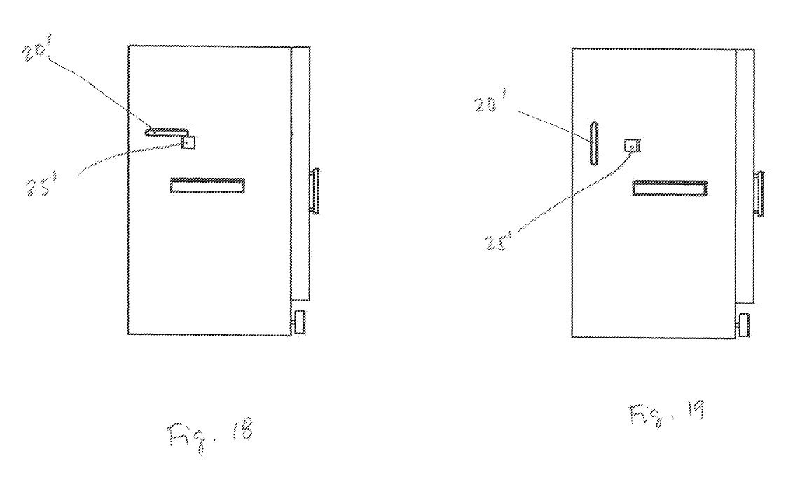

FIG. 18 is a side view of the toaster oven of the present invention depicted in FIG. 13; and

FIG. 19 is a side view of the toaster oven of the present invention depicted in FIG. 12.

### DETAILED DESCRIPTION OF THE INVENTION

Reference will now be made in detail to embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, below, left, and right may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

Referring to the drawings, FIGS. 1-11 in particular, a toaster oven 10 is shown comprising a cooking chamber 17 within housing 18, which chamber 17 is defined by left wall 11, right wall 12, rear wall 13, bottom wall 14, top wall 15 and door 16. Toaster oven 10 also comprises upper heating elements 30 and lower heating elements 40. In a preferred embodiment, heating elements 30 and 40 are fixed and not movable.

The inventive toaster oven 10 further comprises a movable heating element 50 and, in a preferred embodiment, a movable reflector 70. When the toaster oven 10 is not being used as a toaster, movable heating element 50 and reflector 70 rest parallel to rear wall 13 (i.e., in a vertical position) as depicted in, for example, FIGS. 3 and 5. In one embodiment, when the heating element 50 and reflector 70 are parallel to rear wall 13, heating element 50 is disabled so that it gives off no heat. In another embodiment, in such a vertical position, the heating element 50 can be enabled to assist in faster heat up for baking and broiling functions.

The heating element 50 and reflector 70 can be positioned horizontally (as shown in, for example, FIGS. 2, 4 and 6) for toasting functions in order to provide optimum heat to the bottom of the bread slices. In the horizontal position, the reflector 70 defines a toasting space 60 that is smaller than cooking chamber 17 when reflector 70 is in a vertical position.

FIGS. 7-11 show one embodiment of the mechanism for repositioning heating element 50 and reflector 70. The repositioning mechanism comprises position dial 20, first connecting rod 100, second connecting rod 110, third connecting rod 120, lock bracket 130, spring lock 140, lock base 150, bracket 160, and right and left rotating shafts 80 and 90.

In this embodiment, heating element 50 is in a fixed position with respect to reflector 70. A right side of reflector 70 is rotatably connected to right rotating shaft 80, which shaft 80 is attached to right wall 12 of toaster oven 10. A left side of reflector 70 is fixedly connected to left rotating shaft 90, which shaft 90 is fixedly connected to first connecting rod 100. First connecting rod 100 is in movably connected to second connecting rod 110, which in turn is movably connected to third connecting rod 120. Third connecting rod 120 is, in turn, fixedly connected to position dial 20, which in turn is affixed to left wall 11 via lock bracket 130, spring lock 140, lock base 150 and bracket 160 with screws and washers 170.

First, second and third connecting rods 100, 110 and 120 are connected to each other via pins, as known in the art. Position dial 20 takes one of two positions. In one position of position dial 20, second connecting rod 110 is not aligned with third connecting rod 120 and reflector 70 and heating element 50 are in a vertical position such as depicted in, e.g., FIGS. 3, 5, 7 and 9. In the other position of dial 20, second and third connecting rods 110 and 120 are aligned with each other and reflector 70 and heating element 50 are in a horizontal position such as depicted in, e.g., FIGS. 2, 4, 6, 8 and 10.

Referring to FIGS. 12-19, which depict another embodiment of the present invention, a toaster oven 10′ is shown comprising a cooking chamber 17′ within housing 18′, which chamber 17′ is defined by left wall 11′, right wall 12′, rear wall 13′, bottom wall 14′, top wall 15′ and door 16′. Toaster oven 10′ also comprises upper heating elements 30′ and lower heating elements 40′. In a preferred embodiment, heating elements 30′ and 40′ are fixed and not movable. Toaster oven 10′ may also include oven racks 180, as required.

Toaster oven 10′ further comprises a movable heating element 50′ and a movable reflector 70′. When the toaster oven 10′ is not being used as a toaster, movable heating element 50′ and reflector 70′ rest parallel to rear wall 13′ (i.e., in a vertical position) as depicted in, for example, FIGS. 12, 14 and 16. In one embodiment, when heating element 50′ and reflector 70′ are in a vertical position, heating element 50′ is disabled so that it gives off no heat. In another embodiment, in such a vertical position, the heating element 50′ can be enabled to assist in faster heat up for baking and broiling functions.

Heating element 50′ and reflector 70′ can be positioned horizontally (as shown in, for example, FIGS. 13, 15 and 17) for toasting functions in order to provide optimum heat to the bottom of the bread slices. In the horizontal position, reflector 70′ defines a toasting space 60′ that is smaller than cooking chamber 17′ when reflector 70′ is in a vertical position.

The mechanism for repositioning heating element 50′ and reflector 70′ comprises handle 20′ and rod 100′. Heating element 50′ is in a fixed position with respect to reflector 70′, which is fixedly attached to rod 100′. A right side of rod 100′ is rotatably connected to right wall 12′ of toaster oven 10′. In a similar way, a left side of rod 100′ is fixedly connected to handle 20′ through left wall 11′.

Handle 20′ takes one of two positions. In one position, as shown in FIGS. 12, 14, 16 and 19, handle 20′ is normal to bottom wall 14′ (i.e., vertical) and reflector 70′ and heating element 50′ are in a vertical position. In the other position, as shown in FIGS. 13, 15, 17 and 18, handle 20′ is horizontal and reflector 70′ and heating element 50′ are likewise in a horizontal position. Spring latch 25′ is slidable with respect to handle 20′. To maintain this horizontal position, latch 25′ can be slid under an end of handle 20′ as shown in FIG. 13.

As shown in FIG. 16, reflector 70′ and movable heater 50′ are shown positioned vertically against rear wall 13′. Reflector 70′ and heater 50′ are fixedly attached to pivoting rod 100′ which can be manually pivoted by the attached handle 20′. Latch 25′ engages with the handle 20′ to maintain the heater in the horizontal position in the improved toasting orientation. When the improved toasting position of the heater is not needed, handle 20′ can be unlatched from latch 25′ and can be strategically positioned vertically along rear wall 13′ which allows additional height for taller foods to be introduced into the cooking cavity.

It should be appreciated that modifications and alterations obvious to those skilled in the art are not to be considered as beyond the scope of the present invention. For example, pivoting rod 100′ may be replaced by modifying the ends of, e.g., reflector 70′ to have extensions to take the place of the rod 100′. Accordingly, the present invention is intended to embrace all such alternatives, modifications and variances which fall within the scope of the appended claims.

What is claimed is:

1. A toaster oven comprising:
a cooking chamber;
a fixed top heating element;
a movable reflector and
a movable heating element,
wherein the movable reflector defines a toasting chamber smaller than the cooking chamber.

2. The toaster oven of claim 1 further a mechanism for moving the movable reflector and heating element.

3. The toaster oven of claim 2, wherein the mechanism for moving the movable reflector and movable heating element comprises a position dial and connecting rods.

4. The toaster oven of claim 3, wherein the position dial is selectable to one of two positions.

5. The toaster oven of claim 4, wherein in one position of the position dial the movable reflector and movable heating element are in a toasting position.

6. The toaster oven of claim 4, wherein in one position of the position dial the movable reflector and heating element are not in a toasting position.

7. The toaster oven of claim 5, wherein the movable heating element is enabled.

8. The toaster oven of claim 6, wherein the movable heating element is enabled.

9. The toaster oven of claim 6, wherein the movable heating element is disabled.

10. The toaster oven of claim 2, wherein the mechanism for moving the movable reflector and movable heating element comprises a position handle and a rod.

11. The toaster oven of claim 10, wherein the position handle is selectable to one of two positions.

12. The toaster oven of claim 11, wherein in one position of the position handle the movable reflector and movable heating element are in a toasting position.

13. The toaster oven of claim 11, wherein in one position of the position handle the movable reflector and heating element are not in a toasting position.

14. The toaster oven of claim 12, wherein the movable heating element is enabled.

15. The toaster oven of claim 13, wherein the movable heating element is enabled.

16. The toaster oven of claim 13, wherein the movable heating element is disabled.

17. The toaster oven of claim 2, wherein the mechanism for moving the movable reflector and movable heating element comprises a position handle attached to the movable reflector.

18. The toaster oven of claim 17, wherein the position handle is selectable to one of two positions.

19. The toaster oven of claim 18, wherein in one position of the position handle the movable reflector and movable heating element are in a toasting position.

20. The toaster oven of claim 18, wherein in one position of the position handle the movable reflector and heating element are not in a toasting position.

21. The toaster oven of claim 19, wherein the movable heating element is enabled.

22. The toaster oven of claim 20, wherein the movable heating element is enabled.

23. The toaster oven of claim 20, wherein the movable heating element is disabled.
